(19) United States
(12) Patent Application Publication
(10) Pub. No.: US 2024/0243353 A1
(43) Pub. Date: Jul. 18, 2024

(54) AQUEOUS ELECTROCHEMICAL ENERGY STORAGE CELL AND A METHOD FOR MANUFACTURING THE SAME

(71) Applicant: Center for Physical Sciences and Technology, Vilnius (LT)

(72) Inventors: Linas Vilciauskas, Vilnius (LT); Jurga Juodkazyte, Vilnius (LT); Jurgis Pilipavicius, Vilnius (LT); Milda Petruleviciene, Vilnius (LT); Nadezda Traskina, Vilnius (LT)

(21) Appl. No.: 18/150,857

(22) Filed: Jan. 6, 2023

(51) Int. Cl. H01M 10/0563; H01M 4/485; H01M 10/054

(52) U.S. Cl. CPC H01M 10/0563; H01M 4/485; H01M 10/054; H01M 2300/0002

(57) ABSTRACT

The invention relates to an electrochemical energy storage cell containing an aqueous electrolyte solution. The positive and negative electrodes of electrochemical cell are composites comprising ion-insertion materials capable of reversible insertion and extraction of ions. The electrochemical storage cell contains an aqueous electrolyte solution and comprises a reductive additive such as hydrazine added at low concentration. The addition of reducing agent into the aqueous electrolyte solution suppresses parasitic reactions allowing the manufacturing of electrode capacity balanced cells having the positive versus negative electrode charge capacity ratio equal to unity. The balanced electrode charge capacity ratio and the absence of self-consuming electrode charge overcapacity improves cycle lifetime, and reduces self-discharge of such electrochemical cells.

### FIELD OF THE INVENTION

The invention relates to aqueous electrochemical energy storage systems more particularly to rechargeable (secondary) batteries based on inorganic ion insertion electrode materials and aqueous electrolyte solutions with improved performance and reduced manufacturing costs.

### BACKGROUND OF THE INVENTION

Rechargeable or secondary lithium ion batteries are widely used as power sources for portable electronics, electric vehicles and stationary banks due to their high energy and power densities, high efficiency, flexible scaling and mature manufacturing technology. Conventional lithium ion batteries are typically based on composite electrodes mostly comprised of ion insertion type materials such as graphite on the negative side and lithium transition metal oxide or phosphate on the positive side. This type of battery structure is also known as the rocking chair battery. The electrodes are typically separated by an organic solvent-based electrolyte solution with lithium salts dissolved in them. The organic solvent-based electrolyte solution does not decompose, or decomposes in a controlled way to form a protective layer known as the solid electrolyte interphase, in the typical operating voltage window of a lithium ion battery. The typical examples of organic solvents used are ethylene carbonate, propylene carbonate, dimethyl carbonate, etc. The typical examples of lithium salts dissolved in organic solvents are lithium perchlorate, lithium hexafluorophosphate, lithium tetrafluoroborate, lithium bis(trifluoromethanesulfonyl)imide, etc.

Although organic solvent based electrolyte solutions have high electrolytic stability and prevent metals from corrosion they generally have low electric conductivity and are combustible, toxic, and costly to produce and purify. The combustibility of organic solvent based electrolyte solutions is the main safety hazard related to the use, transportation and storage of lithium ion batteries. The replacement of organic solvent by water has a number advantages such as increased electric conductivity, non-cumbustibility, low toxicity, and low cost. Batteries based on aqueous electrolyte solutions do not require dry environments during their production which significantly reduces manufacturing costs. The two prominent examples of aqueous batteries widely used as rechargeable power sources in automotive and electronics industries are the lead-acid and the nickel metal hydride batteries. However, they are based on conversion materials and are not of the rocking chair type and also suffer from such issues as low energy density, limited cycle lifetime, especially under deep discharge conditions in the case of lead-acid batteries or rare and expensive electrode active materials in the case of nickel metal hydride batteries.

Aqueous ion batteries based on ion insertion materials and aqueous electrolyte solutions also known as the aqueous rocking chair batteries solve many of the issues related to lithium ion batteries based on organic electrolytes and traditional aqueous batteries based on conversion materials. They can be designed and manufactured to be more stable and reversable, much safer, lower cost, and based on abundant materials. This is for the most part due to much better ability to control underlying electrochemical processes than in other battery types such as those based on conversion materials.

The operating principles of aqueous ion insertion batteries are common among several monovalent and divalent ions such as Li(I), Na(I), K(I), Mg(II), Ca(II) or Zn(II), the main feature of such systems being the electrode active material capable of reversible insertion of these ions into the one-, two-, or three-dimensional framework structure. Many of the ion insertion electrode materials such as framework compounds having an electrochemically active transition metal center examples being phosphates, hexacyanonometalates, pyrophosphates, fluorophosphates or mixed phosphates with certain crystalline structure examples being olivine, or NASICON structured phosphates or hexacyanoferrates are capable of reversibly inserting the aforementioned types of ions. These materials depending on the transition metal center in their structure could act as both the positive and negative electrode materials and be combined in a single electrochemical cell. The aqueous electrolyte solutions separating the electrodes are either purely aqueous or hybrid (aqueous and organic solvent mixture, examples being dimethylsulphoxide, acetonitrile, ethylene glycol, glycerol) solutions of simple salts which are soluble and electrolytically stable under cell operating conditions, examples being metal sulfates, nitrates, phosphates, hydrogenphosphates, dihydrogenphosphates, acetates, perchlorates, trifluoromethanesulfonates, bis(trifluoromethanesulfonyl)imides.

Parasitic reactions or processes are those which do not contribute to or directly interfere with the electrochemical reactions responsible for reversible charge storage in a battery cell. One source of parasitic reactions is the electrolytic stability of aqueous electrolyte solutions which is intrinsically limited by the thermodynamic cathodic and anodic stability of water. The cathodic stability of water is limited by the hydrogen evolution and the anodic stability by the oxygen evolution reactions, respectively. These reactions and the limited electrolytic stability of aqueous electrolyte solutions are among the main factors affecting energy density, cycle and calendar lifetime, and self-discharge characteristics of aqueous electrochemical energy storage cells and systems. In addition to hydrogen and oxygen evolution, there are a number of other parasitic processes taking place in aqueous batteries such as corrosion of metallic cell components, electrochemical activity of carbonaceous phases, or oxygen reduction reaction due to gaseous oxygen dissolved in the electrolyte solution. During battery operation, these reactions lead to active charge carrying ion inventory loss from the electrodes resulting in unfavorable over-/undercharge and over-/underdischarge conditions. These conditions cause overutilization and underutilization of electrode active materials, decomposition of electrolyte solution and lead to electrode charge imbalance which further results in cell charge capacity loss during charge-discharge cycling of a rechargeable electrochemical cell.

Depending on the type of electrode active materials and battery type, there are various methods to mitigate the parasitic processes such as sacrificial electrolyte additives, protective coatings, catalytic reversal of water decomposition etc. The simplest and widely adopted approach is the design overcapacity of one of the electrodes. This involves the use of an electrode with a larger capacity than the opposite electrode. The capacity ratio typically known as the negative to positive electrode or N/P ratio in the state of the art could be N/P<1 for anode-limited cells or N/P>1 for cathode-limited cells. Such electrode charge overcapacity is typically slowly self-consumed during battery operation by parasitic reactions and ensures active ion and electrode capacity balance. However, such oversizing of one of the electrodes also creates deadweight that lowers the overall energy density of electrochemical cell, adds manufacturing costs and due to its finite amount and self-consuming nature still eventually limits the cell lifetime.

### SUMMARY OF THE INVENTION

In view of the situations described above, it is the principal object of the present invention to provide a rechargeable aqueous electrochemical cell based on ion insertion materials that does not require either negative or positive electrode design overcapacity for mitigation and compensation of parasitic reactions taking place in aqueous electrolyte solutions and stable operation over multiple charge-discharge cycles. An electrochemical cell design with a positive to negative electrode capacity ratio of unity i.e. with neither electrode charge overcapacity is termed an electrode balanced or a N/P=1 cell. Such cell design does not introduce additional deadweight due to oversized electrodes, simplifies the manufacturing of such cells, and as shown in the present invention, improves cell lifetime during charge-discharge cycling, and reduces cell self-discharge.

An aqueous electrochemical energy storage cell according to the present invention is a rechargeable aqueous sodium ion battery cell which includes an aqueous electrolyte solution in which a salt such as sodium sulphate or sodium nitrate is dissolved in water or water and organic solvent such as dimethylsulphoxide mixture separating a positive electrode containing a positive ion insertion active electrode material such as a NASICON structure type phosphate compound that can reversibly insert and extract sodium ions and has a transition metal ion such as vanadium(III) with a redox potential below the anodic stability limit of aqueous electrolyte solution, a negative electrode containing a negative ion insertion active electrode material such as a NASICON structure type compound that can reversibly insert and extract sodium ions and has a transition metal ion such as titanium(IV) with a redox potential above the cathodic stability limit of aqueous electrolyte solution. According to the present invention the positive and negative electrode material might be the same material having two distinct transition metal ions such as vanadium (III) and titanium (IV) satisfying the aqueous electrolytic stability conditions.

The above provisions are solved by the addition of reducing agent such as hydrazine at low concentration to the aqueous electrolyte solutions which mitigates the oxygen reduction reaction and carbon reduction reaction thus no sodium inventory is lost from the positive electrode during the charging process of such electrochemical cell. Therefore, no positive electrode overcapacity is needed during cell manufacturing which reduces costs and simplifies the cell design. The reductive agent such as hydrazine is chemically and electrochemically self-consumed during the early operation cycles of a rechargeable battery cell and allows to balance the sodium inventory between the negative and positive electrodes. The suppression of oxygen reduction reaction also reduces the negative electrode material degradation and improves the self-discharge characteristics of such an aqueous electrochemical energy storage cell.

### BRIEF DESCRIPTION OF DRAWINGS

Features of the invention believed to be novel and inventive are set forth with particularity in the appended claims. The invention itself, however, may be best understood by reference to the following detailed description of the invention, which describes exemplary embodiments, given in non-restrictive examples, of the invention, taken in conjunction with the accompanying drawings, in which:

FIG. 1 depicts a schematic view of an aqueous electrochemical energy storage cell structure. The negative electrode composite 1 contains ion insertion active material. The positive electrode composite 2 contains ion insertion active material. The electrolyte solution 3 is embedded in porous separator film. 4 is the negative current collector. 5 is the positive current collector. 6 is the power source or load. 7 is the connecting wire.

FIG. 2 shows charge capacity retention of a symmetric Na₂VTi(PO₄)₃|Na₂VTi(PO₄)₃ aqueous electrochemical cell during charge discharge cycling at different positive (Q_{C}) to negative (Q_{N}) electrode charge capacity ratios.

FIG. 3 shows charge capacity retention and coulombic efficiency of a symmetric Na₂VTi(PO₄)₃|Na₂VTi(PO₄)₃ aqueous electrochemical cell during charge discharge cycling at positive (Q_{C}) to negative (Q_{N}) electrode charge capacity ratio of unity with and without addition of hydrazine.

FIG. 4 shows charge capacity retention of a symmetric Na₂VTi(PO₄)₃|Na₂VTi(PO₄)₃ aqueous electrochemical cell during charge discharge cycling at positive (Q_{C}) to negative (Q_{N}) electrode charge capacity ratio of unity with different molar concentrations of hydrazine.

FIG. 5 shows evolution of positive and negative potential in a symmetric Na₂VTi(PO₄)₃|Na₂VTi(PO₄)₃ aqueous electrochemical cell during charge discharge cycling at positive (Q_{C}) to negative (Q_{N}) electrode charge capacity ratio of unity with and without addition of hydrazine.

FIG. 6 shows the evolution of the negative Na₂VTi(PO₄)₃ electrode potential during the first charging cycle in a symmetric Na₂VTi(PO₄)₃|Na₂VTi(PO₄)₃ three-electrode Swagelok-type cell with N/P approximately 1.

FIG. 7 shows the cyclic voltammograms of a symmetric Na₂VTi(PO₄)₃|Na₂VTi(PO₄)₃ cells in a three-electrode Swagelok-type cell recorded at 5 mV/s scan rate with and without the addition of hydrazine at 0.1 mol %.

FIG. 8 shows the self-discharge time of a symmetric Na₂VTi(PO₄)₃|Na₂VTi(PO₄)₃ aqueous electrochemical cell at positive (Q_{C}) to negative (Q_{N}) electrode charge capacity ratio of unity with and without addition of hydrazine.

FIG. 9 shows the relative capacity retention of four symmetric Na₂VTi(PO₄)₃|Na₂VTI(PO₄)₃ coin cells with the same positive (Q_{C}) to negative (Q_{N}) electrode charge capacity ratio of approximately 1 with different molar concentrations of hydrazine in hybrid (1 M NaNO₃ in 1:1 DMSO:water) electrolyte.

### DETAILED DESCRIPTION OF THE INVENTION

The following terms and definitions are used throughout the description and can be used interchangeably and still refer to the same element.
Rechargeable electrochemical energy storage (EC ES) cell, rechargeable battery cell, rechargeable battery, secondary battery, secondary battery cell.
Aqueous ion battery, aqueous ion insertion battery, aqueous battery, aqueous electrochemical energy storage cell, aqueous electrochemical battery.
Negative electrode, anode, negatrode, negative side of an electrochemical cell.
Positive electrode, cathode, positrode, positive side of an electrochemical cell.
Electrode/electrolyte interface, electrode interface, electrode surface in a cell.
Capacity balanced cell, cell with positive to negative charge capacity ratio of unity, N/P=1 cell, capacity balanced battery cell, balanced battery cell.

The following description teaches the possible and preferred embodiments of the present invention. Details which would be understood as standard in the art should be inferred where not explicitly stated but would be reasonably understood.

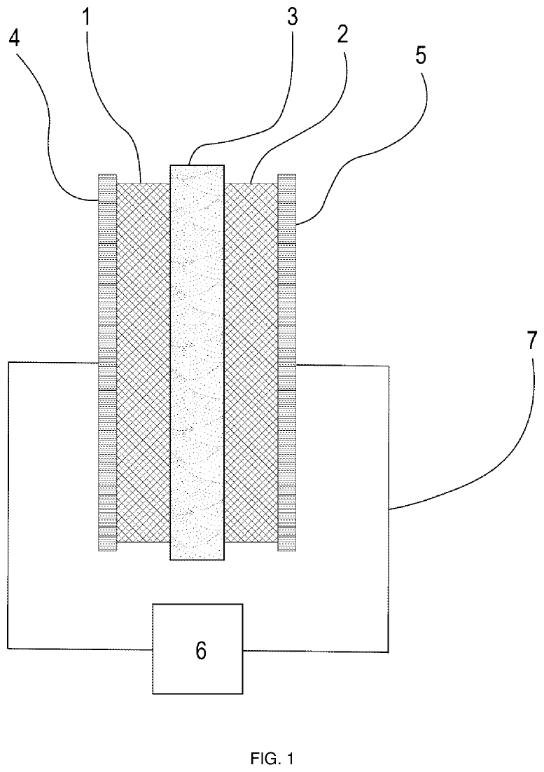

The teachings herein relate to an aqueous electrochemical energy storage cell having electrodes with equal charge capacity comprising a strongly reducing electrolyte additive and method to manufacture the same. The electrochemical energy storage cell has a preferable principal structure to that of FIG. 1 and can have any form or arrangement known in the state of the art such as a planar coin cell, a wound cylindrical cell, a stacked or wound prismatic cell, or a bipolar stack.

The electrode active materials are materials capable of reversible electrochemical insertion of Li(I), Na(I), K(I), Mg(II), Ca(II) or Zn(II) ions into the one-, two-, or three-dimensional framework structure and having an electrochemically active transition metal center which defines the electrode potential examples being phosphates, hexacyanonometalates, pyrophosphates, fluorophosphates or mixed phosphates with certain crystalline structure examples being olivine, or NASICON structured phosphates or hexacyanoferrates. These materials, depending on the transition metal center in their structure, could act as both the positive and negative electrode materials and be combined in a single electrochemical cell.

The strongly reducing electrolyte additive examples being hydrazine, hydrazine hydrate, sodium borohydride, sodium aluminum hydride solves the technical problems arising from oxygen and carbon reduction reactions at the negative electrode/electrolyte interfaces of aqueous battery cells by limiting these parasitic processes especially during the initial charging cycle also known as the formation cycle.

The parasitic reactions typically observed in aqueous EC cells are the electrochemical oxygen reduction reaction on the negative electrode surface:

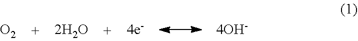

and the chemical oxygen reduction reaction catalyzed by some metals present in electrode materials such as Ti(III):

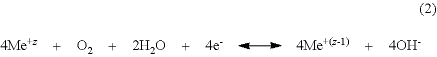

and the electrochemical reduction of surface groups present on carbon used as a particle coating and conducting filler additive in the state of the art battery electrodes:

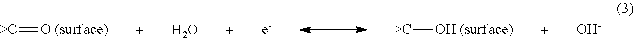

During the first charging cycle, the above mentioned parasitic reactions consume charge carrying ion inventory from the positive electrode which eventually leads to electrode imbalance and capacity loss in subsequent charge-discharge cycles. The strongly reducing agent acts as a chemical oxygen scavenger and competes with the above oxygen reduction reactions through the following mechanism:

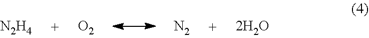

or acts as a chemical reducing agent on the carbonyl functional groups present on the surface of carbon via Wolff-Kishner type reduction:

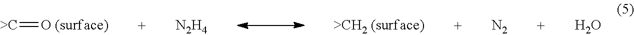

or epoxide groups on the surface of carbon via Wharton type reaction:

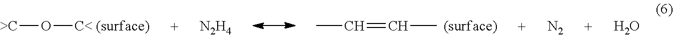

The additive solves two known problems in the art: (I) to reduce the intrinsic (i.e. derived from materials synthesis) carbonaceous phase of an electrode used as an electrically conducting coating of electrode active material particles, as well as carbonaceous filler additive used to improve the electrical conductivity of the electrode and (II) to reduce the oxygen present in aqueous electrolyte solutions because oxygen reduction reaction is known to be one of the main parasitic reactions in aqueous electrochemical energy storage cells. The reduction of carbonaceous phase especially on the negative electrode (anode) and of dissolved oxygen in electrolyte conserves the faradaic charge capacity of the positive electrode (cathode) thus allowing to reduce the need for overcapacity during manufacturing and to achieve charge capacity ratio of unity (balance) between the electrodes. The reduction of dissolved oxygen in aqueous electrolyte solution also prevents the oxidation of the negative electrode (anode) in its charged state thus preventing self-discharge of an aqueous electrochemical energy storage cell. The additive itself could be electrochemically active under aqueous electrochemical oxidizing/reducing conditions and be consumed during the initial (formation) charge-discharge cycles:

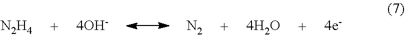

The improved electrode charge capacity balance and reduced self-discharge enable a significant improvement of the cycling capability and lifetime of aqueous electrochemical energy storage systems; additional benefits being reduced material waste and manufacturing costs.

The electrochemical energy storage cell can have any structure known in the state of the art and preferably that of FIG. 1 and can have any form or arrangement known in the state of the art such as a planar coin cell, a wound cylindrical cell, a stacked or wound prismatic cell, or a bipolar stack.

Aqueous EC ES Cell with Additive

The present invention relates to a rechargeable electrochemical energy storage cell having a positive electrode and a negative electrode, both containing an ion such as sodium insertion material such as a NASICON structured Na₂VTi(PO₄)₃ (NVTP) phosphate. The electrolyte solution is disposed between the electrodes and may be any water-based electrolyte solution containing 50 mol % or more water and organic solvent such as dimethylsulphoxide and comprising a soluble metal salt such as sodium sulphate or sodium nitrate at a concentration of 0.1 mol/L or more and further comprising a strongly reducing electrolyte additive such as hydrazine at a concentration of 0.15 mol % or less.

In the aqueous electrochemical energy storage (EC ES) cell according to the present invention, the electrolyte solution may be an aqueous solution that contains a water-soluble metal salt, wherein the metal is able to form an ion in aqueous electrolyte solutions upon dissociation which has known insertion host material into which it can be readily and reversible inserted by electrochemical means. The typical examples of such metals according to the state of the art are lithium, sodium, potassium, magnesium, calcium or zinc. An electrolyte solution may contain some organic co-solvent to form a hybrid electrolyte at low (dilute or “salt-in-water” electrolytes) or high (inverse, super-concentrated or “water-in-salt” electrolyte) salt concentration, wherein in either scheme, water comprises at least 50 mol %.

The water soluble metal salt is one of metal sulfate, nitrate, phosphate, hydrogenphosphate, dihydrogenphosphate, acetate, perchlorate, trifluoromethanesulfonate, bis(trifluoromethanesulfonyl)imide, or a combination thereof. Preferably, the water-soluble metal salt is readily soluble at least at 0.1 mol/L at room temperature (25° C.) in water or hybrid aqueous electrolyte and is stable towards electrochemical oxidation and reduction at typical aqueous battery operating potentials.

In embodiments where an organic solvent is used, said organic solvent is an organic solvent selected from: dimethylsulphoxide, acetonitrile, ethylene glycol, glycerol and combinations thereof.

The present invention teaches the use of a strongly reducing electrolyte additive. A low concentration of the strongly reducing additive at concentration of 0.15 mol % or less is added to the aqueous electrolyte solution described previously. The additive can be one or more of hydrazine, hydrazine hydrate, sodium borohydride, sodium aluminum hydride or another known water soluble strongly-reducing additive that competes with the oxygen and carbon reduction reactions of chemical equations (1) and (3). The additive solves two known problems in the art: (I) to reduce oxygen present in aqueous electrolyte solutions; (II) to reduce the intrinsic (i.e. derived from materials synthesis) carbonaceous phase present on the surface of active electrode material and to reduce the electrically conductive carbonaceous filler typically used to improve the electrical conductivity of the battery electrodes.

The reduction of carbonaceous phase and especially of dissolved oxygen in electrolyte solution and on the negative electrode (anode) conserves the faradaic charge capacity of the positive electrode (cathode) thus allowing to reduce the need for design charge overcapacity during manufacturing and to achieve 1:1 charge capacity ratio (N/P=1 ratio) or balance between the electrodes. The reduction of dissolved oxygen in aqueous electrolyte solution also prevents the oxidation of the negative electrode (anode) by dissolved oxygen in its charged state thus preventing self-discharge of an aqueous electrochemical energy storage cell. The additive itself could be electrochemically active under aqueous electrochemical oxidizing/reducing conditions and be consumed during the initial (formation) charge discharge cycles which also conserves positive electrode charge and ion inventory. The improved electrode charge capacity balance and reduced self-discharge enable a significant improvement of the cycling capability and lifetime of aqueous electrochemical energy storage systems.

The positive and negative electrodes of the electrochemical cell are composites comprising an active material, an electronically conductive carbonaceous filler, and polymeric binder material. The active electrode materials are ion insertion materials such as phosphates, hexacyanonometalates, pyrophosphates, fluorophosphates or mixed phosphates with one-, two- or three-dimensional framework structure capable of reversible electrochemical insertion and extraction of an ion, in accordance with the state of the art. Active materials can be those that are able to reversibly insert and extract metal ions within the electrode potential window. The electrode potential window is defined at the upper limit by the electrode potential at which the aqueous electrolyte solution undergoes oxidation, and the lower limit by the electrode potential at which the aqueous electrolyte solution undergoes reduction. Typically, the thermodynamically defined electrode potential window of water is 1.23 V, however, the kinetic limitations and the composition of the electrolyte solution dictate this window.

In some embodiments, the active material of the positive electrode may be a lithium, sodium, potassium, magnesium, calcium or zinc containing phosphate, hexacyanometalate, pyrophosphate, fluorophosphate or mixed phosphates and have various structures such as NASICON (AₓB₂(PO₄)₃, where x=1-4, A=Li, Na, K, Mg, Ca, or Zn, B=V, Mn, Cr, Co, Ni, Fe, Ti, or Zr)

In some embodiments, the active material of the negative electrode may be a lithium, sodium, potassium, magnesium, calcium or zinc containing phosphate, hexacyanonometalate, pyrophosphate, fluorophosphate or mixed phosphates and have various structures such NASICON (AₓB₂(PO₄)₃, where x=1-4, A=Li, Na, K, Mg, Ca, or Zn, B=V, Mn, Cr, Co, Ni, Fe, Ti, or Zr)

In some embodiments, the active material of the positive and negative electrodes may be the same or each electrode may contain a mixture of more than one active material. The chosen active materials of both electrodes of an EC ES cell of the present invention are ion insertion materials suitable for the same ion, such as Li, Na, K, Mg, Ca, or Zn ion, wherein the electrolyte solution comprises the same active metal ion salt as the active electrode material.

The electrode composites comprise the active materials, which are typically electronic insulators, with carbonaceous filler to increase conductivity in the electrode, and a polymeric binder that binds the composite and further binds the composite electrode to the current collector.

The carbonaceous filler can be one or more of graphite, such as natural graphite, artificial graphite, acetylene black, carbon black, or Ketjen black. In preferred embodiments, the electronically conductive material is carbon black, acetylene black, or Ketjen black. The preferred filler materials have characteristics of improved electronic conductivity, paste forming and current collector coating ability.

The polymeric binder is one or more of polymeric resins, such as poly(vinylidene fluoride) (PVDF), polytetrafluoroethylene (PTFE), polypropylene (PP), polyethylene (PE), natural butyl rubber (NBR), styrene-butadiene rubber (SBR), polyacrylonitrile (PA), or polyurethane (PU) or their co-polymers.

The current collector may be formed of stainless steel, nickel, titanium, aluminum, carbon felt, graphite sheet, graphite paper, polymeric resin and carbon composite, electrically conducting polymer or glass such as indium tin oxide (ITO), or fluorine doped tin oxide (FTO). The current collector may be a foil, a film, a sheet, a mesh, or a foam, which, in any of the constructions, and have a thickness in the range of 5 to 1000 micrometers.

In an exemplary embodiment of the invention, the positive and the negative electrode active material is Na₂VTi(PO₄)₃ having a NASICON-type structure, which has two distinct redox couples with different electrode potentials within the water electrochemical stability window. Therefore, the principle is demonstrated on an aqueous secondary battery cell having a symmetric configuration where both the positive and the negative active material comprises the same compound. During charging the reduction of Ti(IV) to Ti(III) of Na₂VTi(PO₄)₃ is utilized in the negative electrode at the potential of ca. −0.6 V versus the standard hydrogen electrode (SHE) and the oxidation of V(III) to V(IV) of Na₂VTi(PO₄)₃ in the positive electrode at the potential of ca. 0.7 V versus the SHE. The reverse processes of oxidation of Ti(III) to Ti(IV) in Na₂VTi(PO₄)₃ is utilized in the negative electrode and the reduction of V(IV) to V(III) of Na₂VTi(PO₄)₃ in the positive electrode during discharging.

### Method of Manufacture of Aqueous Electrochemical ES Cell Having Charge Balance and Comprising Strongly Reducing Additive

A method of manufacture using the strongly reducing electrolyte additive is taught which enables the manufacture of such an electrochemical cell with equal charge capacity on each electrode. The method of manufacture includes preparation of each component of the EC cell, assembly of the EC cell, and electrochemical formation of the EC cell.

According to the method of manufacture, the positive and negative electrodes may be formed by mixing a chosen active material, an electronically conductive carbon filler, and a binder in an appropriate solvent such as water, N-methylpyrrolidone, dimethylformamide, dimethylacetamide, toluene etc. to prepare a paste or slurry which can be applied to a current collector by doctor blade or slit casting, spray coating, or screen printing, drying the resulting coating and if necessary pressing or calendaring it to increase tap density.

The electrolyte solution is prepared by mixing pure water with a chosen metal ion salt, the salt solution having a concentration of 0.1 mol/L or more, possibly additionally mixing an organic solvent at 50 mol % with respect to water or less, and mixing a low concentration 0.15 mol % or less of the strongly reducing additive to the electrolyte solution.

The EC cell is assembled by sandwiching the positive and negative electrodes cast on current collectors separated by a separator such as glass-fiber, textiles, ion conducting insoluble polymer resin, or paper. The role of the separator being to mechanically separate the electrodes and avoid short circuit. The electrodes are then cut into an appropriate shape and arranged into an appropriate form factor by pressing, rolling, winding, stacking, to achieve a planar coin cell, a wound cylindrical cell, a stacked or wound prismatic cell, a bipolar stack or other cell form according to the state of the art.

### EXAMPLES

In an exemplary, the electrode slurry was prepared by mixing 70 wt % of an Na₂VTi(PO₄)₃ active material, 20 wt % of carbon black and 10 wt % of polyvinylidene fluoride in pure N-methyl-2-pyrrolidone. The slurry was homogenized in a ball-mill for 1 hour at 900 rpm, then cast as a film and dried in a vacuum for 3 hours at 120° C. The resulting electrode film was pressed on SAE 316L grade stainless steel mesh and punched into disks of area approximately 1.33 cm² with an average active material loading of approximately 2 mg cm⁻². The electrolyte solution is a 1 mol/L aqueous Na₂SO₄ solution. The reductive agent is an aqueous solution of hydrazine (N₂H₄) in the concentration range from 0.05 mol % to 0.15 mol %. The cell is assembled either as a coin cell in a stainless steel casing using a Whatman GF/A glass fiber separator, or as a Swagelok-type three-electrode cell with polytetrafluoroethylene casing and stainless steel plungers. The reference electrode in a latter cell was a mercury/mercurous sulfate Hg/Hg₂SO₄ electrode filled with saturated aqueous potassium sulfate solution.

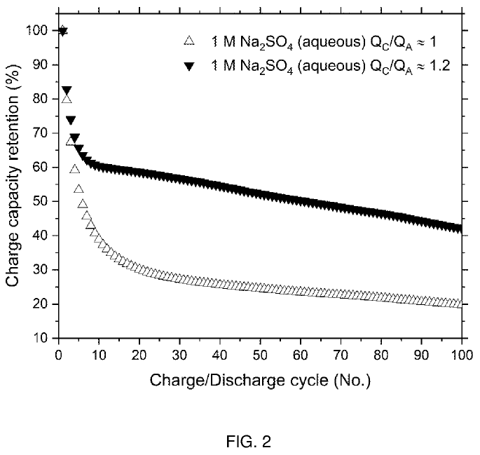

The experimental results of a symmetric cell containing Na₂VTi(PO₄)₃ as a positive electrode material and Na₂VTi(PO₄)₃ as a negative electrode material are shown in FIGS. 2-9 as discussed below. During charge-discharge cycling the Ti(III)/Ti(IV) redox couple is utilized on the negative side and V(III)/V(IV) on the positive side, respectively.

The relative capacity retention of two symmetric Na₂VTi(PO₄)₃|Na₂VTi(PO₄)₃ coin cells with two different positive (Q_{C}) to negative (Q_{N}) electrodes having charge capacity ratios (N/P ratio) of approximately 1 and 1.2 is depicted in FIG. 2. Both cells contained the same Na₂VTi(PO₄)₃ active electrodes materials as cathode and anode and 1 mol/L Na₂SO₄ aqueous electrolyte solution and Whatman GF/A

glass fiber separator. The cells were cycled at 1 C rate (62.5 mA g⁻¹ based on the mass and theoretical capacity of anode). The introduction of excess positive electrode capacity of ca. 20% leads to significantly improved capacity retention of more than two times after 100 cycles. According to the state of the art, the positive excess overcapacity could be increased even more and optimized for the best overall capacity retention and battery cell performance.

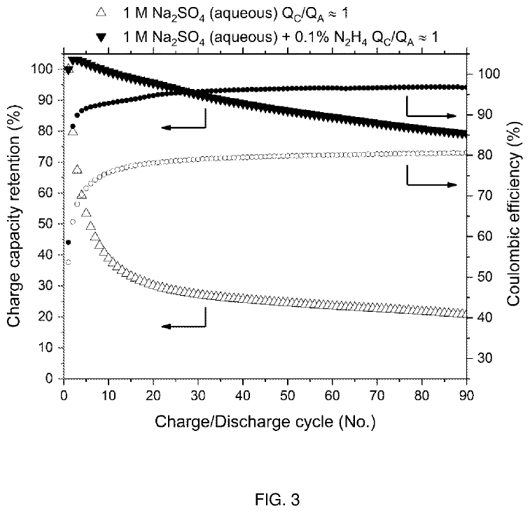

The relative capacity retention of two symmetric Na₂VTi(PO₄)₃|Na₂VTI(PO₄)₃ coin cells with the same positive (Q_{C}) to negative (Q_{N}) electrode charge capacity ratio (N/P ratio) of approximately 1 is depicted in FIG. 3. Both cells contained the same Na₂VTi(PO₄)₃ active electrodes materials as cathode and anode and Whatman GF/A glass fiber separator. The cells were cycled at 1 C rate (62.5 mA g⁻¹ based on the mass of anode). The electrolyte solution was aqueous 1 mol/L Na₂SO₄ with and without the addition of 0.1 mol % of hydrazine. The introduction of 0.1 mol % of hydrazine into the electrolyte leads to significantly improved capacity retention of more than two times after 90 cycles even without the introduction of positive electrode overcapacity.

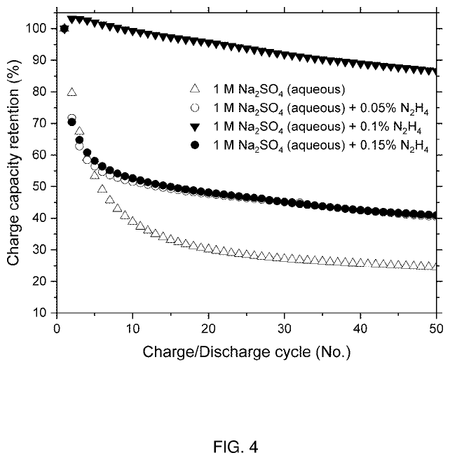

The relative capacity retention of four symmetric Na₂VTi(PO₄)₃|Na₂VTi(PO₄)₃ coin cells with the same positive (Q_{C}) to negative (Q_{N}) electrode charge capacity ratio (N/P ratio) of approximately 1 is depicted in FIG. 4. All four cells contained the same Na₂VTi(PO₄)₃ active electrodes materials as cathode and anode and Whatman GF/A glass fiber separator. The cells were cycled at 1 C rate (62.5 mA g⁻¹ based on the mass of anode). The electrolyte solution was aqueous 1 mol/L Na₂SO₄ without and with the addition of different concentration (0.05 mol %, 0.1 mol %, 0.15 mol %, respectively) of hydrazine. The introduction of 0.1 mol % of hydrazine into the electrolyte leads to the most optimal capacity retention in terms of hydrazine concentration.

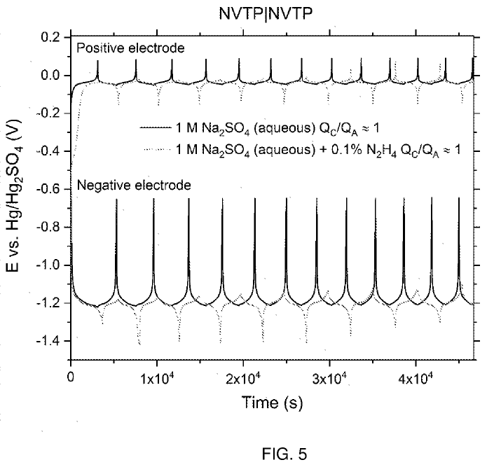

The variation of the positive and negative electrode potentials in symmetric Na₂VTi(PO₄)₃|Na₂VTi(PO₄)₃ cells in a three-electrode Swagelok-type cell with N/P˜1 is depicted in FIG. 5. All cells contained the same Na₂VTi(PO₄)₃ active electrodes materials as cathode and anode and Whatman GF/A glass fiber separator. The cells were cycled at 1 C rate (62.5 mA g⁻¹ based on the mass of anode). The electrolyte solution was aqueous 1 mol/L Na₂SO₄ with and without the addition of hydrazine (0.1 mol %). The introduction of 0.1 mol % of hydrazine conserves the charge capacity of sodium in the initial charging cycles and eliminates the over discharge conditions on the negative electrode leading to improved charge balance during cycling and longer lifetime.

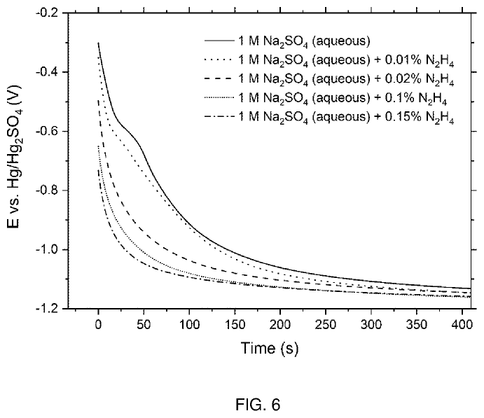

The evolution of the negative Na₂VTI(PO₄)₃ electrode potential during the first charging cycle in a symmetric Na₂VTi(PO₄)₃|Na₂VTi(PO₄)₃ cells in a three-electrode Swagelok-type cell with N/P˜ 1 is shown in FIG. 6. The electrolyte solution was aqueous 1 mol/L Na₂SO₄ without and with the addition of different concentration (0.01 mol %, 0.02 mol %, 0.1 mol %, 0.15 mol %, respectively) of hydrazine. The potential value at the initial time corresponds to the open circuit potential. The reduction of the open circuit potential of the negative electrode shows the effect of the reducing agent on the electrode which mostly comprises the reduction of oxygen containing functional groups on the surface of carbonaceous electrode components. The parasitic reactions such as oxygen reduction and carbonaceous phase reduction are visible as a bump in the potential curve which disappears in cells having progressively higher hydrazine content.

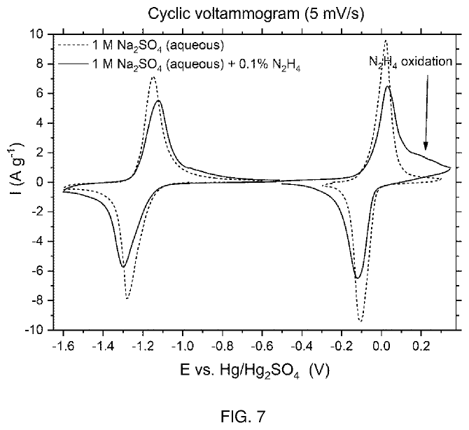

The cyclic voltammograms of a symmetric Na₂VTi(PO₄)₃|Na₂VTi(PO₄)₃ cells in a three-electrode Swagelok-type cell recorded at 5 mV/s scan rate with and without the addition of hydrazine at 0.1 mol % is shown in FIG. 7. The voltammogram shows that reductive agent is electrochemically active towards oxidation. Therefore, the excess additive could be electrochemically consumed at the positive electrode in the early charge-discharge cycles and does not further participate in any electrochemical reactions taking place in the electrochemical cell.

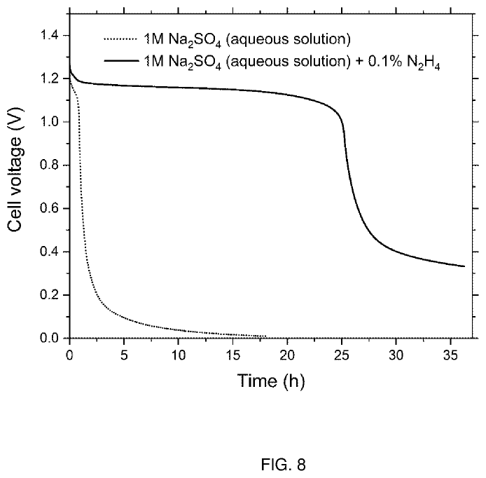

The self-discharge time of a symmetric Na₂VTi(PO₄)₃|Na₂VTi(PO₄)₃ aqueous electrochemical cell at positive (Q_{C}) to negative (QA) electrode charge capacity ratio of unity with and without addition of hydrazine is shown in FIG. 8. The addition of the reductive agent such as hydrazine reduces the cell self-discharge which is caused by the parasitic reactions such as oxygen reduction on the charged negative electrode. An approximately 25 fold increase in the self-discharge time is observed in a cell containing 0.1 mol % of hydrazine.

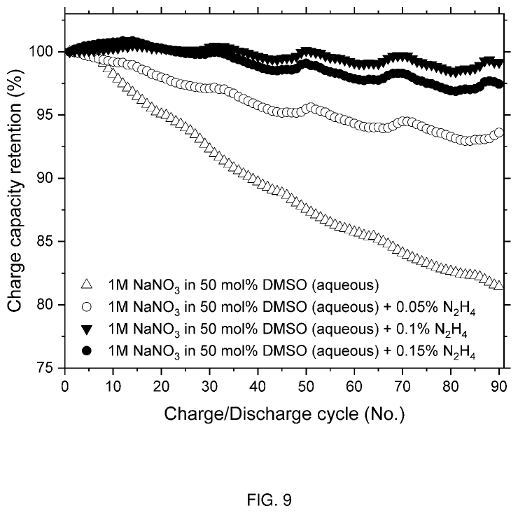

The relative capacity retention of four symmetric Na₂VTi(PO₄)₃| Na₂VTi(PO₄)₃ coin cells with the same positive (Q_{C}) to negative (QA) electrode charge capacity ratio of approximately 1 (N/P=1) is shown in FIG. 9. All four cells contained the same Na₂VTi(PO₄)₃ active electrodes materials as cathode and anode and Whatman GF/A glass fiber separator. The cells were cycled at 1 C rate (62.5 mA g⁻¹ based on the mass of anode). The hybrid electrolyte solution was a 50 mol % dimethylsulphoxide (DMSO) 50 mol % aqueous 1 mol/L NaNO₃ without and with the addition of different concentration (0.05 mol %, 0.1 mol %, 0.15 mol %, respectively) of hydrazine. The introduction of 0.1 mol % of hydrazine into the hybrid electrolyte leads to the most optimal capacity retention in terms of hydrazine concentration.

1. An energy storage cell comprising:
a positive electrode containing an active material that can reversibly insert and extract monovalent and multivalent ions such as lithium, sodium, potassium, magnesium, calcium or zinc;
a negative electrode containing an active material that can reversibly insert and extract monovalent and multivalent ions such as lithium, sodium, potassium, magnesium, calcium or zinc;
an electrolyte solution disposed between the positive and the negative electrode, the electrolyte solution being an aqueous solution with water content of 50 mol % or more in which a monovalent or divalent ion salt is dissolved; and further comprising a strongly reducing electrolyte additive.

2. The energy storage cell of claim 1, wherein the positive electrode comprises an active material with a redox potential within the electrochemical stability window of aqueous electrolyte.

3. The energy storage cell of claim 1, wherein the negative electrode comprises an active material with a redox potential within the electrochemical stability window of aqueous electrolyte.

4. The energy storage cell of claim 1, wherein the electrolyte additive is one of hydrazine, hydrazine hydrate, sodium borohydride or sodium aluminum hydride.

5. The energy storage cell of claim 1, wherein the electrolyte further comprises an organic solvent at a concentration of 50 mol % or less with respect to water.

6. The energy storage cell of claim 1, wherein the positive electrode and negative electrode active material is Na₂VTi(PO₄)₃.

7. The energy storage cell of claim 1, wherein the positive and negative electrodes further comprise electronically conductive filler and binder material.

8. A method of manufacture of an aqueous rechargeable electrochemical energy storage cell, the method comprising:
producing a positive electrode that comprises an active material capable of reversible insertion and extraction of monovalent ions;
producing a negative electrode that comprises an active material capable of reversible insertion and extraction of monovalent ions;
wherein the stoichiometric capacity of ions in the positive electrode and negative electrode active material is the same such that there is no over-capacity of the positive electrode;
preparing an electrolyte solution comprising at least 50 mol % water, a metal ion salt, and a strongly reducing additive;
assembling the energy storage cell by sandwiching the electrolyte between the positive and negative electrodes;
forming the assembly into the energy storage cell.

9. The method of claim 8, wherein the positive electrode comprises an active material with a redox potential within the electrochemical stability window of aqueous electrolyte.

10. The method of claim 8, wherein the negative electrode comprises an active material with a redox potential within the electrochemical stability window of aqueous electrolyte.

11. The method of claim 8, wherein the electrolyte additive is one of hydrazine, hydrazine hydrate, sodium borohydride or sodium aluminum hydride.

12. The method of claim 8, wherein the electrolyte further comprises an organic solvent.

13. The method of claim 8, wherein the positive electrode and negative electrode active material is Na₂VTi(PO₄)₃.

14. The method of claim 8, wherein the positive and negative electrodes further comprise electronically conductive filler and binder material.
